(19) United States
(12) Patent Application Publication
(10) Pub. No.: US 2010/0318966 A1
(43) Pub. Date: Dec. 16, 2010

(54) METHOD FOR STARTING SCA-BASED WAVEFORM APPLICATION IN COMPONENT START ORDER

(75) Inventors: Sang Chul Oh, Daejeon (KR); Nam Hoon Park, Daejon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATAIONS, DAEJEON (KR)

(21) Appl. No.: 12/517,922

(22) PCT Filed: Oct. 2, 2007
(86) PCT No.: PCT/KR07/04809

§ 371 Date: Jun. 5, 2009

(30) Foreign Application Priority Data
Dec. 7, 2006 (KR) 10-2006-0124184

(51) Int. Cl. G06F 9/44

(52) U.S. Cl. 717/120

(57) ABSTRACT

A method for starting an SCA-based waveform application includes defining information on start order of components in a domain profile; and starting a waveform application in the start order according to the information. Further, the waveform application is executed by using the method including: creating an application X by an application factory; parsing, by the application factory, the information on the start order of the components defined in the domain profile to be transmitted to the application X; receiving the information from the application X and storing the information in the assembly controller; and calling a start of the application X when a start command is received; calling a start of the assembly controller by the application X; executing components in the start order based on the information stored in the assembly controller.

### TECHNICAL FIELD

The present invention relates to a method for starting a SCA-based waveform application in component start order. This work was supported by the IT R&D program of MIC/IITA. [2006-S-012-01, Development of Middleware Platform Technology based on the SDR Mobile Station]

### BACKGROUND ART

Software Communications Architecture (SCA) is a standardized communications software architecture proposed to greatly enhance interoperability between communications systems and reduce a cost for research and deployment by Joint Tactical Radio System (JTRS) Joint Program Office (JPO) of the United States. The SCA guarantees portability and configurable capability of software and hardware devices and guarantees interoperability between products which are built upon the SCA. The SCA employs, as middleware, adopting Common Object Request Broker Architecture (CORBA) of an industry standard of an object model to provide the infrastructure for various hardware device and software to work together. The SCA is an independent system design framework, not limited to a specific system. An SCA-based system is a communication system built upon the SCA. For example, a Software Defined Radio (SDR) system has adopted the SCA as a standard of a software framework.

A basic architecture of SCA software is mainly formed by a Real Time Operating System (RTOS), a CORBA middleware, a Core Framework (CF), and an application. The application in the SCA performs functions of a single waveform. Therefore, several components are assembled in a single package to be installed, deployed, and implemented.

Communications protocols are generally designed as Open System Interconnection (OSI) seven layer model having several layers from the lowermost physical layer to the uppermost application layer. Each layer has relations of service user (upper layer)-service provider (lower layer) with the layer above and below. Therefore, even if the upper layer (service user) starts, the upper layer (service user) cannot provide any service without starting the lower layer, so that an error occurs. To avoid the occurrence of the error, there are provided two solutions: the first is to overcome an error by serving different initialization processes to an upper layer and a lower layer, and the second is to prevent an error by starting in a sequence, i.e., from a lower layer to an upper layer. The first has difficulties in applying to the SCA whose key feature is waveform component portability. In detail, a component A and a component B are required to communicate based on the SCA with each other even if they are produced by different manufacturers. To that end, a global standard of the initialization process defined in the SCA is needed to every component, but there is no such a definition in the SCA. Conventionally, therefore, when a waveform application based on the SCA is started, each of the components described in a domain profile is started randomly by an assembly controller, without any criterion. As a result, it is impossible to overcome the start error occurrence in a protocol application for communications in which start order is critical.

### DISCLOSURE OF INVENTION

### Technical Problem

In view of the above, the present invention provides a method for, when a waveform application starts, controlling start order of each component in SCA, thereby preventing the occurrence of error caused by starting an upper layer component earlier than a lower layer component.

### Technical Solution

In accordance with a first aspect of the present invention, there is provided a domain profile in a Software Communications Architecture (SCA), comprising a part for defining information on start order of components.

In accordance with a second aspect of the present invention, there is provided a method for starting an SCA-based waveform application, the method comprising: defining information on start order of components in a domain profile; and starting a waveform application in the start order according to the information.

### ADVANTAGEOUS EFFECTS

The present invention can explicitly control the start order of each component when a waveform application in the SCA is started. Therefore, the present invention can prevent an upper layer component from starting earlier than a lower layer component.

### BRIEF DESCRIPTION OF THE DRAWINGS

The objects and features of the present invention will become apparent from the following description of preferred embodiments given in conjunction with the accompanying drawings, in which:

FIG. 1 illustrates a basic structure of an SCA-based system;

FIG. 2 is illustration of running a waveform application in SCA in accordance with an embodiment of the present invention;

FIG. 3 shows a domain profile specification including information on component start order;

FIG. 4 is a procedure diagram describing a method for starting components in the SCA; and

FIG. 5 provides a table form in an assembly controller, storing the SCA component start order.

### BEST MODE FOR CARRYING OUT THE INVENTION

Hereinafter, embodiments of the present invention will be described in detail with reference to the accompanying drawings so that they can be readily implemented by those skilled in the art.

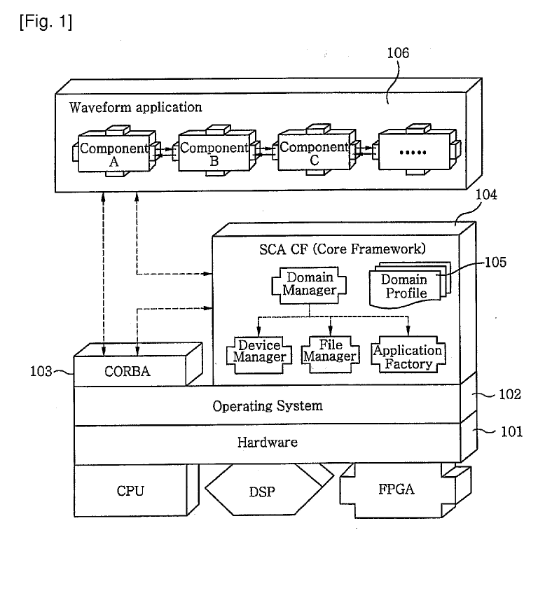

FIG. 1 illustrates a basic structure of an SCA-based system. In the SCA system, Operating System (OS) 102, CORBA 103, and SCA Core Framework (CF) are arranged above hardware 101 such as a Central Processing Unit (CPU), a Digital Signal Processor (DSP), and a Field Programmable Gate Array (FPGA). A domain profile 105 in the SCA CF 104 is a set of XML file that describes characteristics of software components and hardware devices that make up the system in order to deploy and connect components. Therefore, an application program 106 can be dynamically designed. The domain profile 105 includes the characteristics such as interfaces, capabilities in terms of function, logical positions, inter-dependencies, and concerning parameters and the like of the hardware devices and the software components. Managers of the CF use the domain profile in the SCA CF to deploy the components in the upper waveform application 106 to corresponding hardware devices and implements thereof. The components transmit and receive information with each other for communications by using ports defined by the SCA.

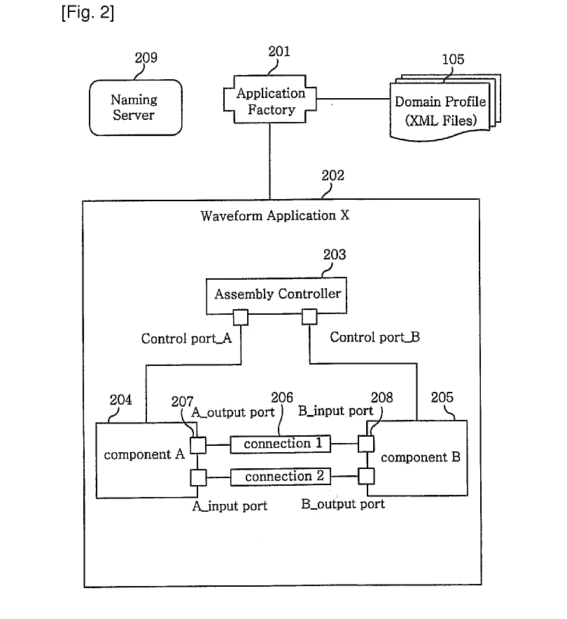

FIG. 2 shows an embodiment running waveform application in the SCA. In the SCA, it is recommended to define all information on a waveform application in domain profiles that is a type of XML file and refer to the information when the application is executed. Therefore, an application factory 201 parses the information in the domain profile 105 to create a waveform application X 202. An assembly controller 203 in the application factory 201 manages corresponding components. The assembly controller 203 transmits control information to corresponding components through a control port. In the SCA, it is recommended to register the assembly controller 203 and all components in a CORBA naming server 209. As a result, all the components can retrieve the registered information to find the other component for communication and to communicate with it. However, it is recommended that ports of components are managed by the respective components without registration to the naming server. Therefore, each component contains connection information for communication with the other component wherein the connection is recommended to be one-way. For example, as shown in FIG. 2, if a component A 204 intends to transmit information to a component B 205, the component A 204 transmits the information to an A_output port 207 in a connection 1 206. The A_output port 207 is defined as transmitting to a B_output port so that the A_output port 207 transmits the information to the B_output port 208. Further, transmission from the component B to the component A is carried out as the same way.

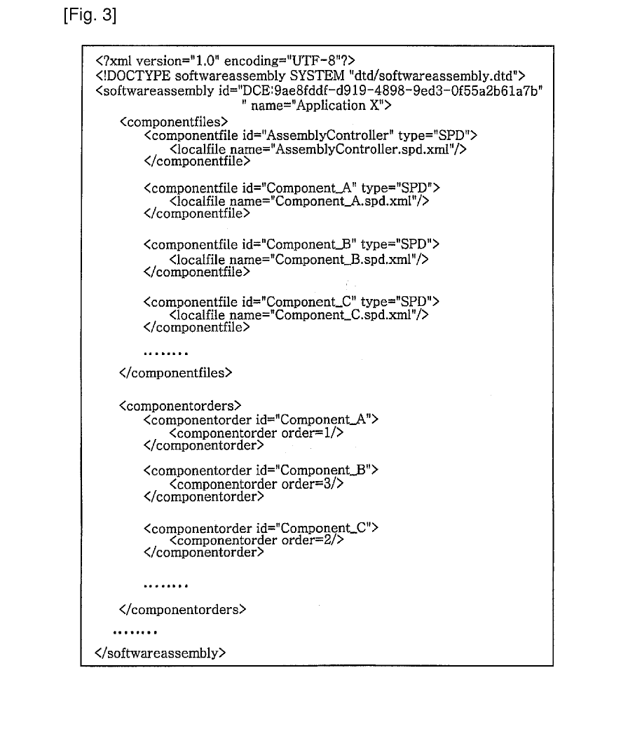

FIG. 3 is an embodiment of a domain profile specification created as a form of a XML file to define start order of components in accordance with an embodiment of the present invention. In FIG. 3, “componentfiles” represents a Software Package Description (SPD) file for each component forming the application X, and “componentorders” has values representing the start order and an IDentification (ID) of each component. The values are required to be assigned in a sequence of a lower layer to an upper layer considering characteristics of communications protocols.

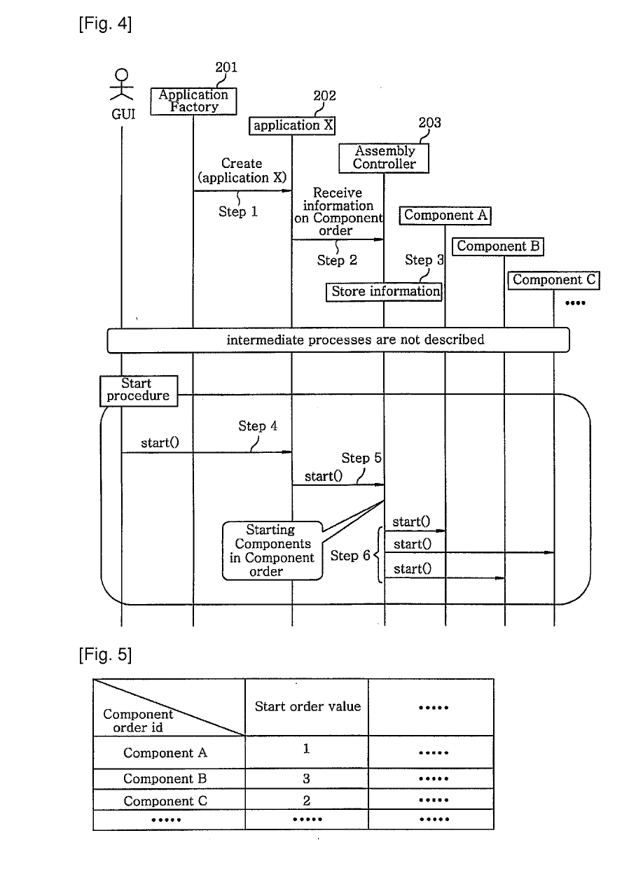

FIG. 4 is a procedure diagram describing a method for starting components in start order according to the information in the domain profile as afore-mentioned. The method for the sequentially starting components in accordance with an embodiment of the present invention will be described with reference to FIG. 4.

An application X is created by an application factory (Step 1). Information on start order of components defined in a domain profile such as in FIG. 3 is parsed by the application factory to be transmitted to the application X. Here, the application X can control the components through the assembly controller. The assembly controller receives the information from the application X (Step 2) and stores therein the information (Step 3). When storing the information, the assembly controller may use a table form shown in FIG. 5. Therefore, the assembly controller can control all components belonging to a single application X to be started in the order as stored in the table form of FIG. 5.

When a user inputs a start command, start of the application X is called (Step 4). Next, start of the assembly controller is called by the application X (Step 5). After that, each component is executed in the order according to the information stored in the assembly controller (Step 6).

The present invention can explicitly control the start order of each component when a waveform application in the SCA is started. Therefore, the present invention can prevent an upper layer component from starting earlier than a lower layer component.

While the invention has been shown and described with respect to the preferred embodiments, it will be understood by those skilled in the art that various changes and modifications may be made without departing from the spirit and scope of the invention as defined in the following claims.

1. A domain profile in a Software Communications Architecture (SCA), comprising a part for defining information on start order of components.

2. A method for starting an SCA-based waveform application, the method comprising:
defining information on start order of components in a domain profile; and
starting a waveform application in the start order according to the information.

3. The method of claim 2, wherein the waveform application is executed by using the method comprising:
creating an application X by an application factory;
parsing, by the application factory, the information on the start order of the components defined in the domain profile to be transmitted to the application X;
receiving the information from the application X and storing the information in the assembly controller; and
calling a start of the application X when a start command is received;
calling a start of the assembly controller by the application X;
executing components in the start order based on the information stored in the assembly controller.

4. The method of claim 2, wherein the information on the start order of the components defined in the domain profile is arranged in a table form by parsing the domain profile.

5. The method of claim 3, wherein the information on the start order of the components defined in the domain profile is arranged in a table form by parsing the domain profile.
